(19) United States
(12) Patent Application Publication
(10) Pub. No.: US 2007/0036458 A1
(43) Pub. Date: Feb. 15, 2007

(54) Digital signal processing apparatus and digital signal processing program

(75) Inventor: Hiroki Sato, Kurokawa-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJI PHOTO FILM CO., LTD., Minami-Ashigara-shi (JP)

(21) Appl. No.: 11/492,799

(22) Filed: Jul. 26, 2006

(30) Foreign Application Priority Data
Aug. 12, 2005 (JP) 2005-234001

(51) Int. Cl. G06K 9/40

(52) U.S. Cl. 382/275; 382/260

(57) ABSTRACT

A digital signal processing apparatus, comprises: a wavelet transforming device comprising an interleave transformer that divides and rearranges an input digital image signal by dividing the input digital image signal into a plurality of regions by down-sampling and a wavelet transformer that decomposes the rearranged digital Image signal Into a low-frequency sub band and a high-frequency sub band by wavelet transformation, wherein the interleave transformer further divides and rearranges the decomposed each of low-frequency sub band and the decomposed high-frequency sub band into a plurality of regions; and a coring device that executes a coring process to data of the high-frequency sub band. It is provided that a digital signal processing apparatus that can restrain generation of ringing and noise in a digital image signal.

### CROSS REFERENCE TO RELATED APPLICATION

This application is based on Japanese Patent Application 2005-234001, filed on Aug. 12, 2005, the entire contents of which are incorporated herein by reference.

### BACKGROUND OF THE INVENTION

A) Field of the Invention

This invention relates to a digital signal processing apparatus, and more in detail, a digital signal processing apparatus that executes a noise reduction of a digital image signal by using a wavelet transformation.

B) Description of the Related Art

FIG. 5A, FIG. 5B and FIG. 6 are schematic views for explaining a two-dimensional wavelet transformation of the digital image signal. FIG. 5A is a block diagram showing an outline of a wavelet transformation device 1, and FIG. 5B is a block diagram showing an outline of a inverse wavelet transformation device 2. FIG. 6 is a plan view schematically showing an image signal to which the wavelet transformation is executed.

The wavelet transformation device 1 includes a wavelet transformation unit 11 and an interleaf transform unit 5.

When a digital image signal X0 is Input to the wavelet transformation unit 11, it is transferred to a low path filter LPF and a high path filter HPF. Each of a high-frequency-filtered (a low frequency component) signal filtered by the low path filter LPF and a low-frequency-filtered (a high frequency component) signal filtered by the high path filter HPF is transferred to a down-sampling unit 4 and a half of signals in a horizontal direction is culled to be frequency-decomposed to the sub-band data of the low frequency component in the horizontal direction L and the high frequency component in the horizontal direction H.

The low frequency component In the horizontal direction L is transferred to the low path filter LPF and the high path filter HPF. After that, each of them is transferred to the down-sampling unit 4 and is culled to a half in the vertical direction to be decomposed into sub-band data of a component LL1 consisting of low frequency components in the horizontal and vertical directions and a component LH1 consisting of a low frequency component In the horizontal direction and a high frequency component in the vertical direction. Also, the high frequency component in the horizontal direction H is transferred to the low path filter LPF and the high path filter HPF. After that, each of them is transferred to the down-sampling unit 4 and is culled to a half in the vertical direction to be decomposed into sub-band data of a component HH1 consisting of high frequency components in the horizontal and vertical directions and a component HL1 consisting of a high frequency component In the horizontal direction and a low frequency component in the vertical direction. Each of the decomposed sub-band data (LL1, LH1, HH1, HL1) is rearranged by an Interleave transformation unit 5 to be arranged as a screen 100b shown in the upper right section in FIG. 6.

In the wavelet transformation unit 11, a reflexive transform can be executed to a desired sub-band data. For example, sub-band data (LL2, LH2, HH2 and HL2) shown In the lower right section in FIG. 6 can be obtained by re-inputting the horizontal and vertical low frequency component LL1 as an input signal X0 to the wavelet transformation unit 11. As described in the above, sun-band data in a specific frequency band can be obtained by repeating the reflexive transform by predetermined times to a predetermined sub-band data.

The wavelet inverse transform device 2 is consisted of a wavelet inverse transform unit 22 and an interleave inverse transform unit 5. The wavelet inverse transform unit 22 recovers the decomposed sub-band data by executing the Inverse transform, and the Interleave Inverse transform unit 5 reconstructs the recovered data to the original image.

FIG. 7 is a block diagram for explaining a noise reduction process according to a conventional digital signal processing apparatus 200 used the wavelet transformation.

The digital signal processing apparatus 200 decomposes a digital image signal X0 to the sub-band data LL1, LH1, HH1 and HL1 by the wavelet transformation already explained with reference to FIG. 5A to FIG. 6. Moreover, the sub-band data LL of low frequency components in the horizontal and vertical directions is further processed by the wavelet transformation, and transformation of the obtained sub-band data LL of low frequency components in the horizontal and vertical directions is repeated for predetermined(n) times (for example, two to eight times) to obtain sub-band data LLn, LHn, HHn and HLn. A coring process described later is executed to the obtained sub-band data LHn, HHn and HLn, and the original image signal is recovered by repeating the inverse wavelet transformations. By executing these processes, for example, low band noise can be restrained as In Japanese Laid-Open Patent 2003-134352. Besides, in this specification, further executing the wavelet transformation to the sub-band data obtained by the wavelet transformation is called “a reflexive wavelet transformation”.

FIG. 8A and FIG. 8B and FIG. 9A to FIG. 9E are graphs for explaining the coring process.

FIG. 8A is a graph showing a relationship between an input signal and an output signal without the coring process. The coring process is, for example, a process for controlling the signal when an absolute value of the input signal is lower than the threshold value (for example, making the signal Impartially “0” when the signal equals to a threshold value or less than the threshold value). When the coring process is executed to the signal with the relationship shown in FIG. 8A, the input signal lower than the threshold value is out put as “0” to get a relationship of the input signal and the output signal shown in FIG. 8B.

More in detail, the wavelet transformation is executed to the Input signal X0 shown In FIG. 9B to decompose it to the low frequency component L1 shown in FIG. 9B and the high frequency component H1 shown in FIG. 9C, and the coring process is executed to the high frequency component H1. By doing that, the high frequency component H1 of which a part lower than the threshold value (a part surrounded by a dotted line) is set to “0” can be obtained. Then, a recovered signal X0′ of which the noise is reduced as shown in FIG. 9E can be obtained by executing the inverse wavelet transformation to the low frequency component L1 and a high frequency component H1′.

As the above-described conventional digital signal processing apparatus, when the reflexive wavelet transformation is repeated and the coring process to the sub-band of the specific band is executed in order to reduce the specific band noise, ringing is generated on the image based on the recovered signal, and an amplitude phase may be changed. Also, to reduce the noise in the specific band, a gap of the phase will be accumulated.

### SUMMARY OF THE INVENTION

It is an object of the present invention to provide a digital signal processing apparatus that can control generation of ringing and a digital signal noise.

According to one aspect of the present invention, there is provided a digital signal processing apparatus, comprising: a wavelet transforming device comprising an interleave transformer that divides and rearranges an input digital image signal by dividing the input digital Image signal into a plurality of regions by down-sampling and a wavelet transformer that decomposes the rearranged digital image signal into a low-frequency sub band and a high-frequency sub band by wavelet transformation, wherein the interleave transformer further divides and rearranges the decomposed each of low-frequency sub band and the decomposed high-frequency sub band into a plurality of regions; and a coring device that executes a coring process to data of the high-frequency sub band.

According to another aspect of the present invention, there is provided a digital signal processing apparatus, comprising: a sampling device that divides and rearranges an input digital image signal into a plurality of regions by down sampling at an arbitrary magnification; a wavelet transforming device comprising a wavelet transformer that decomposes the rearranged digital image signal into a low-frequency sub band and a high-frequency sub band by wavelet transformation and an interleave transformer that divides and rearranges the decomposed each of low-frequency sub band and the decomposed high-frequency sub band into a plurality of regions: and a coring device that executes a coring process to data of the high-frequency sub band.

According to the present invention, generation of ringing is restrained, and a digital signal processing apparatus that can reduce the digital signal noise can be provided.

### BRIEF DESCRIPTION OF THE DRAWINGS

FIG. 1 is a block diagram showing a structure of a digital signal processing apparatus 101 according to a first embodiment of the present invention.

FIG. 2 is a schematic view for explaining a digital signal process according to the first embodiment of the present invention.

FIG. 3 is a block diagram showing a structure of a digital signal processing apparatus 102 according to a second embodiment of the present invention.

FIG. 4 is a schematic view showing a digital signal process according to the second embodiment of the present invention.

FIG. 5A and FIG. 5B are block diagrams showing outlines of a wavelet transformation unit and a inverse transform unit.

FIG. 6 is a plan view schematically showing the image signal executed the wavelet transformation.

FIG. 7 is a block diagram for explaining a noise reduction process according to a conventional digital signal processing apparatus 200 used the wavelet transformation.

FIG. 8A and FIG. 8B are graphs for explaining the coring process.

FIG. 9A to FIG. 9E are graphs for explaining the coring process.

### DETAILED DESCRIPTION OF THE PREFERRED EMBODIMENTS

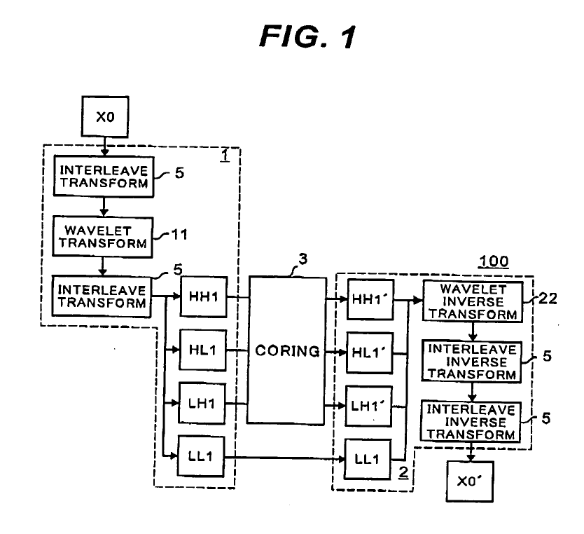

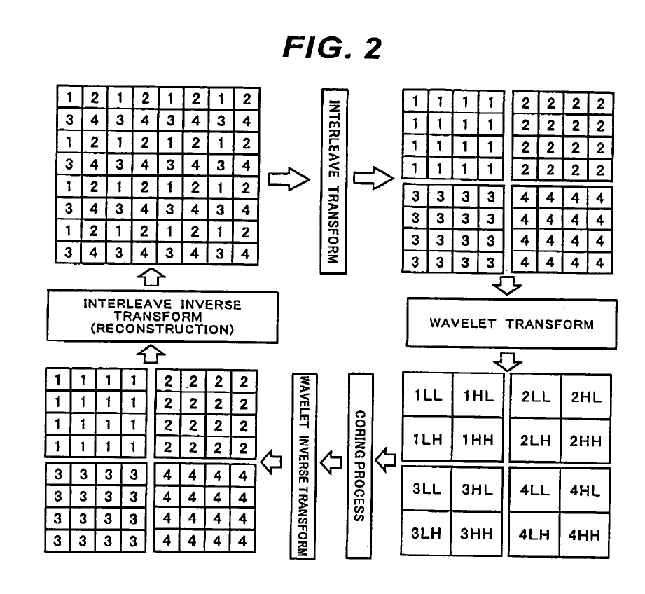

FIG. 1 is a block diagram showing a structure of a digital signal processing apparatus 101 according to a first embodiment of the present invention. FIG. 2 is a schematic view for explaining a digital signal process according to the first embodiment of the present invention.

A digital signal processing apparatus 101 includes at least a wavelet transformation device 1, an Inverse wavelet transformation device 2, and a coring processing unit 3. The digital signal processing apparatus 101 decomposes an input digital image signal X0 to sub-band data of predetermined bands by the wavelet transformation. Then, a coring process is executed to a component of low frequency in a horizontal direction and high frequency in a vertical direction (horizontal low and vertical high frequencies component) LH1, a high frequency component in the horizontal direction (horizontal and vertical high frequencies component) HH1 and a component of high frequency In a horizontal direction and low frequency in a vertical direction (horizontal high and vertical low frequencies component) HL1 (hereinafter, these three sub-ban data are generically called a high frequency sub-band data) with reference to a low frequency component LL1 in the horizontal and vertical directions (hereafter called a low frequency sub-band data) to eliminate or reduce a noise component.

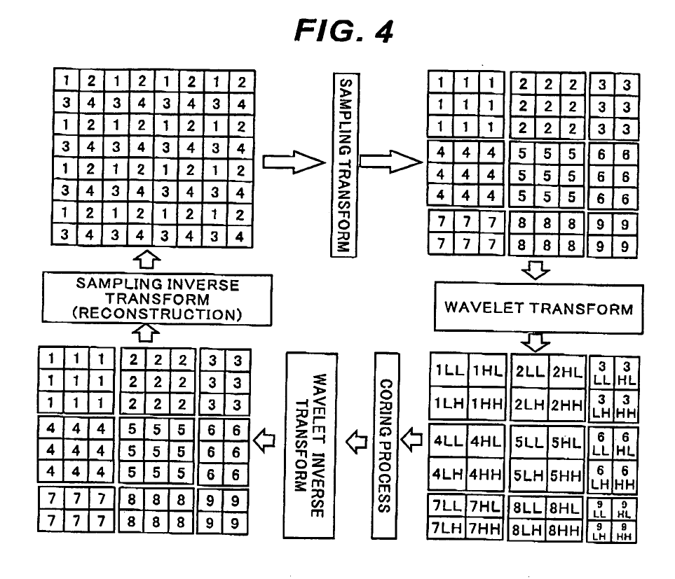

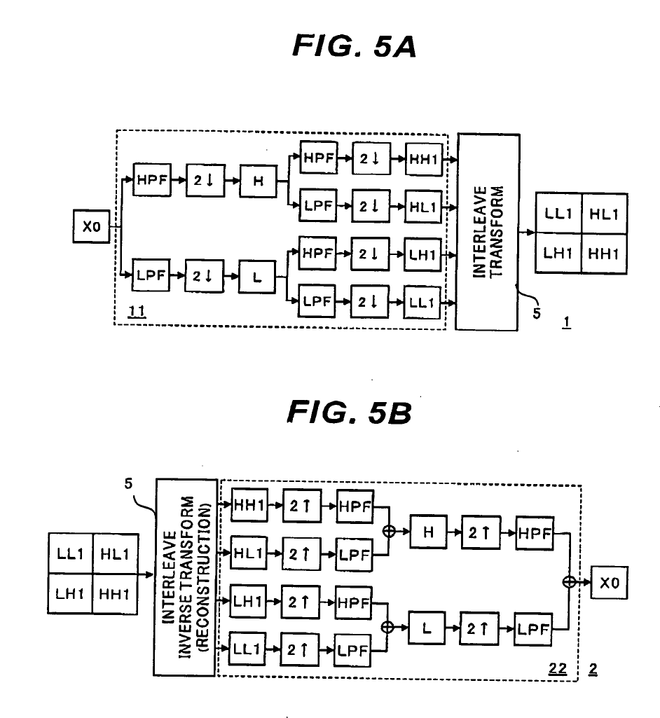

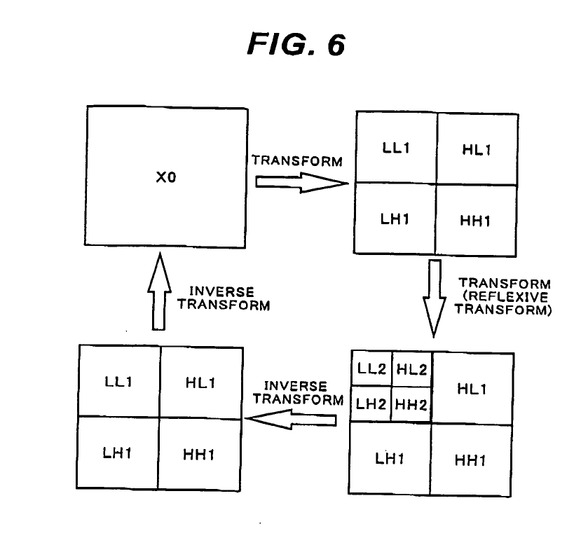

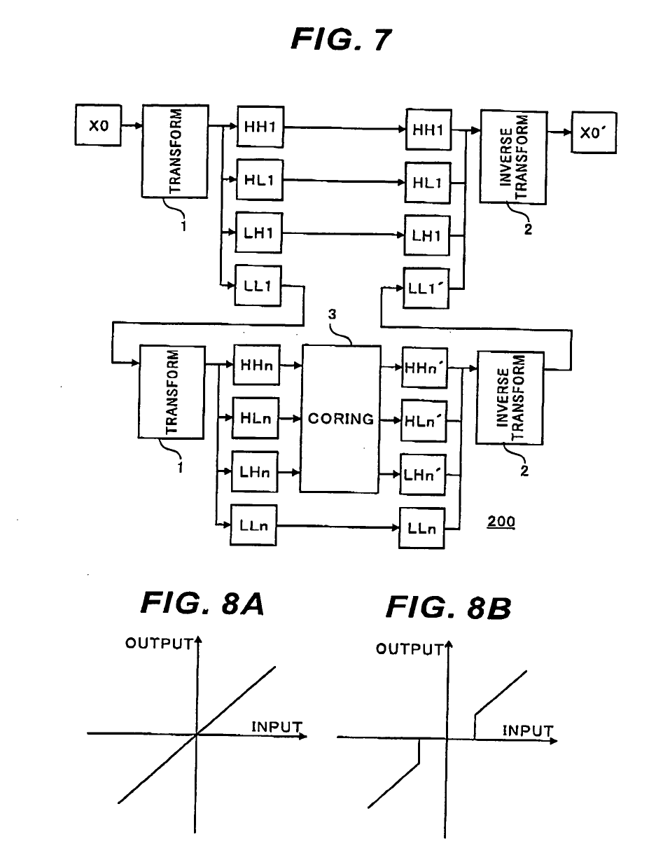

The wavelet transformation device 1 includes a wavelet transformation unit 11 and an interleave transformation unit 5 as same as the conventional wavelet transformation device 1 shown in FIG. 4. In this embodiment, the digital image signal X0 shown in an upper left section of FIG. 2 is just ¼ down-sampled by the interleave transformation unit 5 to rearrange (reposition) the digital image signal into four regions as shown in the upper right in FIG. 2. After that, the rearranged image signal is input to the wavelet transformation unit 11, and each one of the four separated regions is decomposed to low frequency sub-band data, i.e., the low frequency components in the horizontal and vertical directions LL1 to LL4 and high frequency sub-band data including a component of low frequency in the horizontal direction and high frequency in the vertical direction LH1 to LH4, a component of high frequency in the horizontal and vertical directions HH1 to HH4 and a component of high frequency In a horizontal direction and low frequency in a vertical direction HL1 to HL4. Each of the decomposed sub-band data is further rearranged (repositioned) to further four regions in each region shown In lower right In FIG. 2 by the interleave transformation unit 5.

In the conventional wavelet transformation device, the interleave transformation unit 5 only rearranges the sub-band data decomposed by the wavelet transformation unit 11; however, the input image signal is justly down-sampled by the interleave transformation unit 5 before the wavelet transformation by the wavelet transformation unit 11 in this embodiment. By doing that, as shown in the lower right in FIG. 2, the sub-band data decomposed to low frequency bands for each sub-band data can be obtained without the reflexive wavelet transformation executing to each sub-band data.

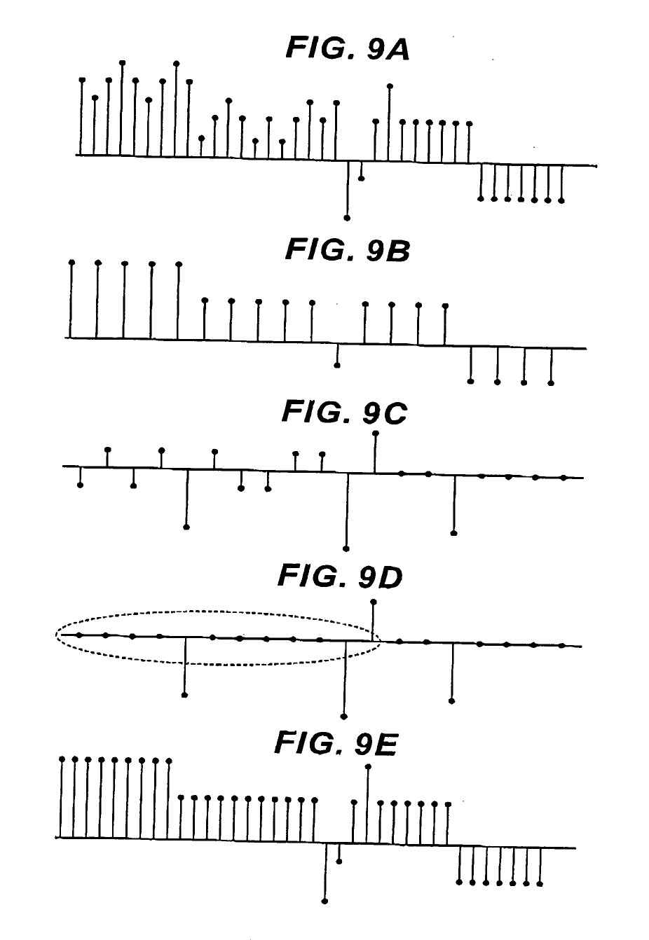

Next, a coring process is executed to each high frequency sub-band data In the four regions on the screen by a coring processing unit 3. This coring process is the same process as the conventional coring process explained with reference to FIG. 8A and FIG. 8B and FIG. 9A to FIG. 9E. That is, the coring process is a process for controlling the signal when an absolute value of the input signal is lower than the threshold value (for example, making the signal impartially “0” when the signal equals to a threshold value or less than the threshold value).

After that, the inverse wavelet transformation unit 2 executes an inverse wavelet transformation to the low frequency sub-band data and the high frequency sub-band data in each region processed by the coring process, and the Inverse interleave transformation unit 5 further rearranges them into four regions on the screen shown In the lower left In FIG. 2. That is, they are recovered to a state shown in the upper right in FIG. 2 In terms of a signal arrangement. Thereafter, they are reconstructed to have the same signal arrangement as the original input signal shown in the upper left in FIG. 2.

As described in the above, in the first embodiment of the present invention, the input image signal is justly down-sampled by the interleave transformation unit 5 to be decomposed into plural regions, and the wavelet transformation is executed to each of the decomposed regions by the wavelet transformation unit 11. Therefore, the low band sub-band data that is the same as in the case when the reflexive wavelet transformation is executed to each sub-band data can be obtained for each of the above-described plural regions.

Moreover, by executing the coring process to each high frequency sub-band data in each region obtained by the above-described process, a noise reduction effect that is same as in a case when the reflexive wavelet transformation and coring process are executed can be obtained. Moreover, in the embodiment, since the reflexive wavelet transformation is not executed, generation of ringing by that can be restrained.

Besides, the above-described embodiment has been explained with an example of quarter down-sampling; however, when the number of divided regions is a reciprocal of a multiple of two, the down-sampling can be executed at an arbitrary magnification. For example, when a one-eighth down-sampling is executed, the sub-band data of the low band that is the same as in a case when the reflexive wavelet transformation is executed twice can be obtained. As same as the above, when a one-sixteenth down-sampling is executed, the sub-band data of the low band that is the same as in a case when the reflexive wavelet transformation is executed three times can be obtained.

In the above-described first embodiment, there is an advantage to be realized with the same hardware as in the conventional signal processing device using the conventional wavelet transformation; however, the magnification of the down-sampling is limited to be reciprocal of a multiple of two. Therefore, a signal processing apparatus 102 that can eliminate the limitation is explained in the below as a second embodiment.

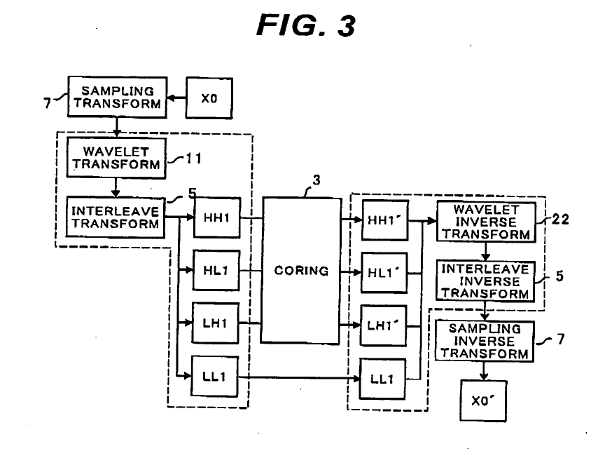

FIG. 3 is a block diagram showing a structure of a digital signal processing apparatus 102 according to the second embodiment of the present invention. FIG. 4 is a schematic view showing a digital signal process according to the second embodiment of the present invention,

A difference between the second embodiment and the first embodiment is that a sampling transformation unit 7 that can execute the down-sampling at an arbitrary magnification is equipped at a preceding part of the wavelet transformation device 1 in the second embodiment. Here, the down-sampling that is executed by the Interleave transform 5 is executed by the sampling transformation unit 7 instead of the interleave transformation unit 5 before the wavelet transformation by the wavelet transformation unit 11.

The sampling transformation unit 7 can, for example, execute the down-sampling at a magnification other than the reciprocal of a multiple of two such as one-ninth as shown in FIG. 4. That is, according to the second embodiment of the present invention, pure down-sampling can be executed at a magnification such as one-third, one-fifth and one-ninth before the wavelet transformation by the wavelet transformation unit 11. Moreover, the down-sampling at the same magnification as the interleave transformation unit 11 can be executed.

As described In the above, the sub-band data of the frequency band that cannot be obtained by the ordinary reflexive wavelet transformation can be obtained by executing the wavelet transformation after the down-sampling at the arbitrary magnification. Therefore, even in a frequency band of which noise cannot be eliminated or reduced by the ordinary reflexive wavelet transformation the noise can be eliminated or reduced by the second embodiment. Moreover, in this second embodiment, since the reflexive wavelet transformation is not executed just same as in the first embodiment, generation of ringing by the reflexive wavelet transformation can be restrained.

As described in the above, according to the first embodiment and the second embodiment, the same noise reduction as In a case using the reflexive wavelet transformation can be realized without the reflexive wavelet transformation, and generation of ringing by the reflexive wavelet transformation can be restrained.

The present invention has been described in connection with the preferred embodiments. The invention is not limited only to the above embodiments. It is apparent that various modifications, improvements, combinations, and the like can be made by those skilled in the art.

What are claimed are:

1. A digital signal processing apparatus, comprising:
a wavelet transforming device comprising an interleave transformer that divides and rearranges an input digital image signal by dividing the input digital image signal into a plurality of regions by down-sampling and a wavelet transformer that decomposes the rearranged digital image signal into a low-frequency sub band and a high-frequency sub band by wavelet transformation, wherein the interleave transformer further divides and rearranges the decomposed each of low-frequency sub band and the decomposed high-frequency sub band into a plurality of regions; and
a coring device that executes a coring process to data of the high-frequency sub band.

2. A digital signal processing apparatus, comprising;
a sampling device that divides and rearranges an input digital image signal into a plurality of regions by down sampling at an arbitrary magnification;
a wavelet transforming device comprising a wavelet transformer that decomposes the rearranged digital image signal into a low-frequency sub band and a high-frequency sub band by wavelet transformation and an Interleave transformer that divides and rearranges the decomposed each of low-frequency sub band and the decomposed high-frequency sub band into a plurality of regions; and
a coring device that executes a coring process to data of the high-frequency sub band.

3. A digital signal processing program executed by a digital signal processing apparatus, comprising: a wavelet transforming device comprising a wavelet transformer that decomposes a digital image signal into a low-frequency sub band and a high-frequency sub band by wavelet transformation and an interleave transformer that divides and rearranges data Into a plurality of regions; and a coring device that executes a coring process to data of the high-frequency sub band, the program comprising:
(a) a first interleave instruction for dividing and rearranging an input digital image signal into a plurality of regions by down sampling;
(b) a wavelet transforming instruction for decomposing the rearranged digital image signal into a low-frequency sub band and a high-frequency sub band by wavelet transformation;
(c) a second interleave instruction for dividing rearranging the decomposed each of low-frequency sub band and the decomposed high-frequency sub band into a plurality of regions; and
(d) a coring instruction for executing a coring process to data of the high-frequency sub band.
